(19) United States
(12) Patent Application Publication
(10) Pub. No.: US 2018/0197124 A1
(43) Pub. Date: Jul. 12, 2018

(54) Method of generating, assigning and managing a software (or an electronic) token/stub/rolling number (a.k.a queue token or a wait token) either by selecting or scanning a QR Code or a Bar-Code or a NFC Tag or any other electronic interfaces through a personal mobile device/s AND invoking integrated services using published visual interfaces through a personal mobile device/s.

(71) Applicant: Hitender Tholia, Sunnyvale, CA (US)

(72) Inventor: Hitender Tholia, Sunnyvale, CA (US)

(21) Appl. No.: 15/403,161

(22) Filed: Jan. 10, 2017

(51) Int. Cl. G06Q 10/06; G06K 7/14; G06K 7/10

(52) U.S. Cl. CPC G06Q 10/0633; G06K 7/10297; G06K 7/1417; G06K 7/1413

(57) ABSTRACT

This invention provides a common process of generating and managing wait tokens. A token is a placeholder in a queue assigned by a business or office to their patrons so as to regulate and dispense services on a first come first serve basis. Existing process involves dispensing physical tokens, but the new method will have software token generated, dispensed and managed via electronic devices like smart phones and tablets and over web and mobile platforms.

A business will be able to span as many queues without having to worry about logistics and will manage the queues seamlessly. This invention can also associate services to QR Codes and thus request for a service will be as simple as scanning the QR Code. Using this method the service providers can service the requesters and manage the process efficiently.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Businesses like retail chains, shops, stores, pharmacies, DMVs, banks, restaurants, doctor clinics, test labs etc. which provide service/s to customers showing up at their doors (a.k.a foot traffic) generally want to regulate and manage the incoming foot traffic so as to serve in an orderly manner and on first come first serve basis.

To manage and provide services efficiently to the incoming foot traffic, businesses generally implement some form of queuing on their premise i.e. as and when the customer walks in the doors they are required to stand in a queue for the services they desire, for example in restaurants there is a front reception where a patron provides his/her name and the party size, the desk attendant adds that information to a wait list. As and when the space opens up for seating, the parties are called as per the order in list and are seated.

Another example is of the department of motor vehicle (DMV), where people go to get driving licenses, vehicle registration and avail many other services. At DMV, a customer joins a queue depending on their requirement. For example there could be a queue for “Behind the Wheel Driving Test”, another queue for “Vehicle Title & Registration”, another queue could be for “Temporary Licenses” etc. Queues at DMV may have a token system, which a customer grabs in order to consume the intended service. A DMV agent calls the next token in the queue to be serviced.

More traditional implementation of token system can also be found at businesses, but not limited to, like a doctor's clinic or a test lab, at box stores and at government agencies like IRS field offices and at many city, state and county offices.

The invented method addresses the above process of token generation and management. Invented method utilizes both software (as in mobile app & backend services) and hardware (as in mobile phones) to scan visual codes, generate, allocate and manage a running token/stub and assign these electronic tokens to mobile devices.

### BRIEF SUMMARY OF THE INVENTION

Businesses use different ways to manage and service their customers. Tokens are used in various forms like paper stubs, medallions, hardware buzzers and printing it on customers purchase receipt.

Invented method is a process, which brings together all these diverse forms of tokens into a common format. In this new method a business creates a queue online and publishes it. A customer coming into the business can join the online queue by scanning a published interface image (like a QR Code) display on premise using mobile phone. A successful scan provides the customer with a wait token in the mobile app. Additionally a customer can also join the same queue remotely. Customer needs to search the queue publish online and join it by clicking the search result.

Incase where a business has integrated services, the service could be invoked the same way a queue is joined. Difference being the integrated service would invoke a landing page after the QR Code is scanned or clicked. An example of integrated service could be of a QR Code scan which will bring up a menu in a restaurant and a customer can order, pay and receive a token, all in the same mobile interface.

### ADVANTAGES

1. This invented method reduces the requirement of human interactions to manage a queue.
2. This invented method also removes the requirement of a physical queue.
3. The invented method frees up resources and increases productivity.
4. This method removes the necessity of physical token (like paper stubs), hardware (electronic buzzers) etc. from the process
5. This method is environmental friendly
6. This method is dynamic and can be extended with ease.
7. This method can be extended to integrated services like Ordering, Purchase and Payments, Appointments etc.

### BRIEF DESCRIPTION OF DRAWINGS

FIG. 1: Registering for Queue

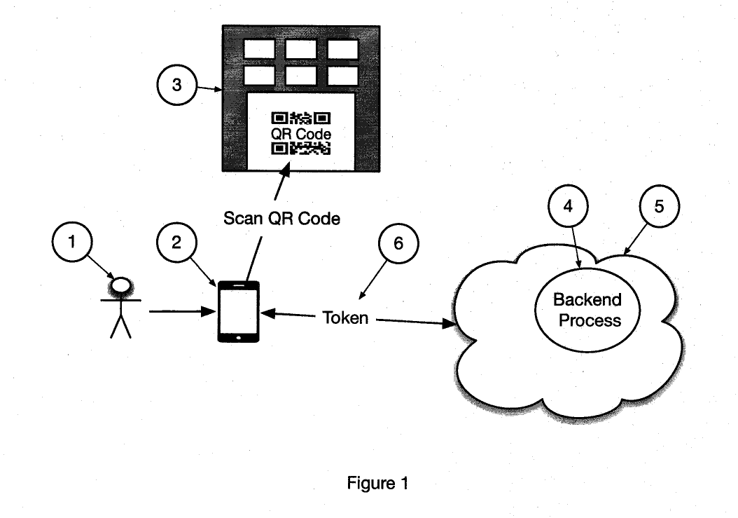

The drawing FIG. 1 shows the request for a token. A user (1) at a business/office (3) scan a context specific QR Code or any other displayed interface. The scanning of which generates a request and the response is a token (6), which is received by the user device (2). A successful generation of a token is confirmation for the user that he/she has joined the queue.

FIG. 2: Business Registration & QR Code Creation

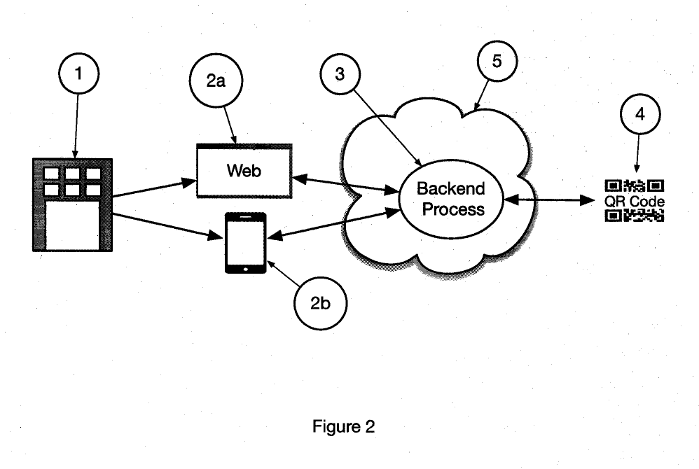

This drawing FIG. 2 represents the process of registration of business activities and creation of QR Codes. A business (1) intending to register an activity will go on web (2a) or mobile (2b) and fill out the registration form. Completion of business registration generates a request for approval process. After successful approval of business, the business activity is provided a QR Code (4). Admin account for the business can add additional activities. Each activity thus added will have a QR Code generated.

FIG. 3: Business Queue Management Screen

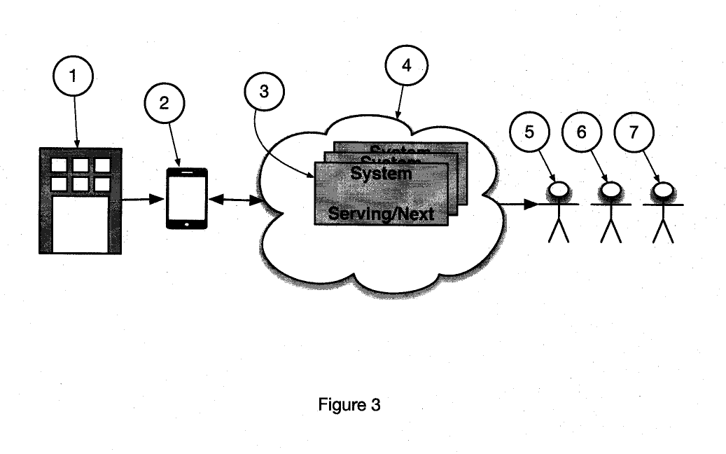

This drawing FIG. 3 represents the process of managing queues (3) by a business (1). Any changes in the status of queue, associated customers (5,6,7) get updated. Multiple markers like estimated wait time, currently serving token etc. are provided to customers.

Joining Queue Locally or Remotely

FIG. 4a: Drawing represents joining a queue when on premise. In FIG. 4a a customer (1) who is present on premise, scans a QR Code (3) using his/her mobile device (2). Upon successful scan processing, the customer receives a token (4) and joins the queue (5).

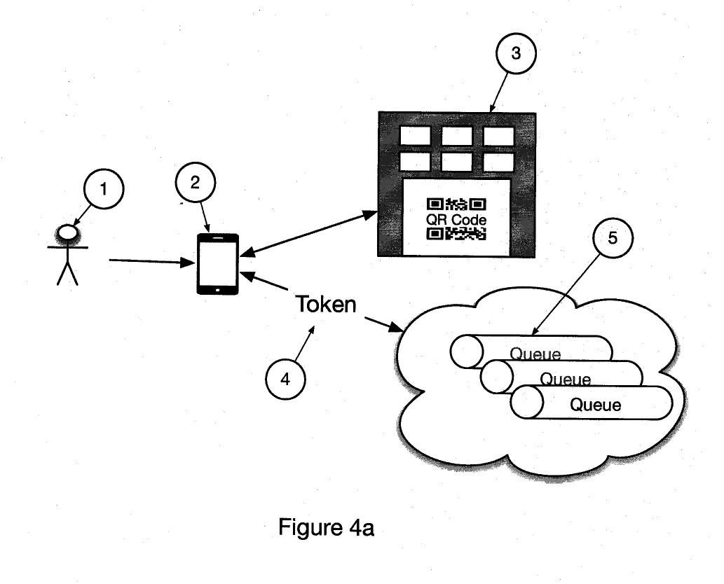

FIG. 4b: Drawing represents method of joining a queue remotely, i.e. when the customer is not physically present on a business premise. A customer (1) searches for a business store online and clicks the QR Code (3) from the search result, which in turn registers the customer with the queue (4) and generates a token (5).

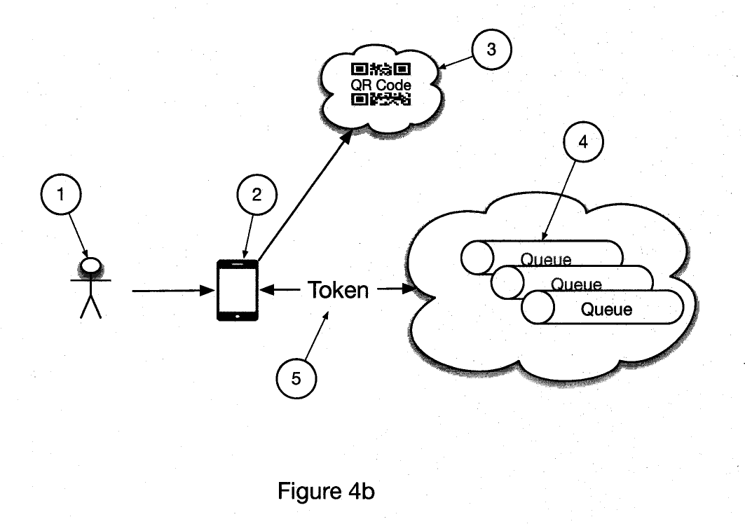

QR Code Invoked Services

FIG. 5a: Drawing represents the process of invoking an integrated service shown here, an appointment calendar (4). A customer searches for the service or scans the QR Code (3). The services get invoked after a successful scan. Customer (1) can then choose the appointment slot, which is most suitable.

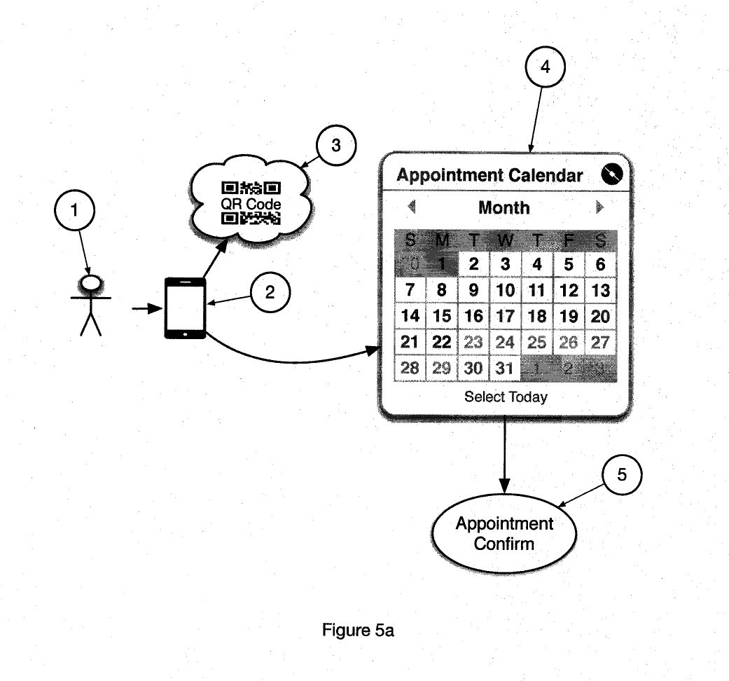

FIG. 5b: Drawing represents the process of invoking an integrated service, which pulls up an invitation confirmation. A user (1) who receives a QR Code (3) is the invited guest and scanning or selecting the QR Code will pull up a confirmation screen (4). Upon confirming, the user is added to the list of confirmed attendees (5) and is provided with a token (6). At the venue door the token is serviced.

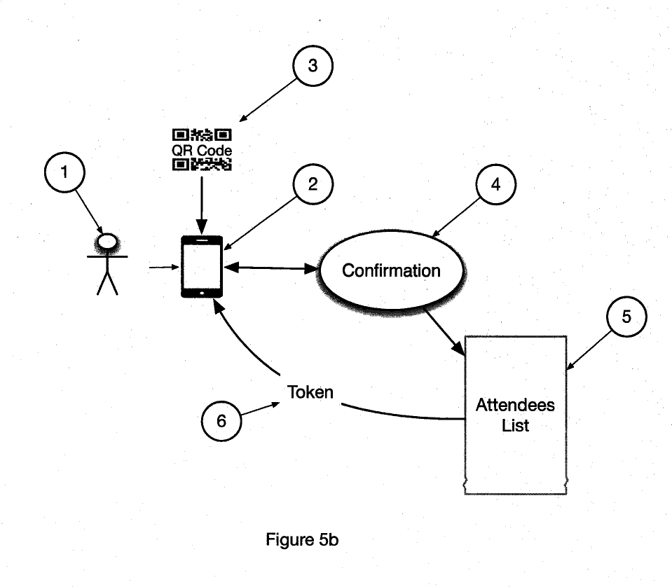

FIG. 5c: Drawing represents the process of ordering and buying using integrated services. A customer scans the store QR Code (3) and a list of items (4) for sale are presented. If the user chooses to buy, a cart service (5) then accepts purchase information and processes the order. A purchase receipt (6) along with a token (7) is generated which is serviced by on premise fulfillment center (8) or at a window to pickup the order.

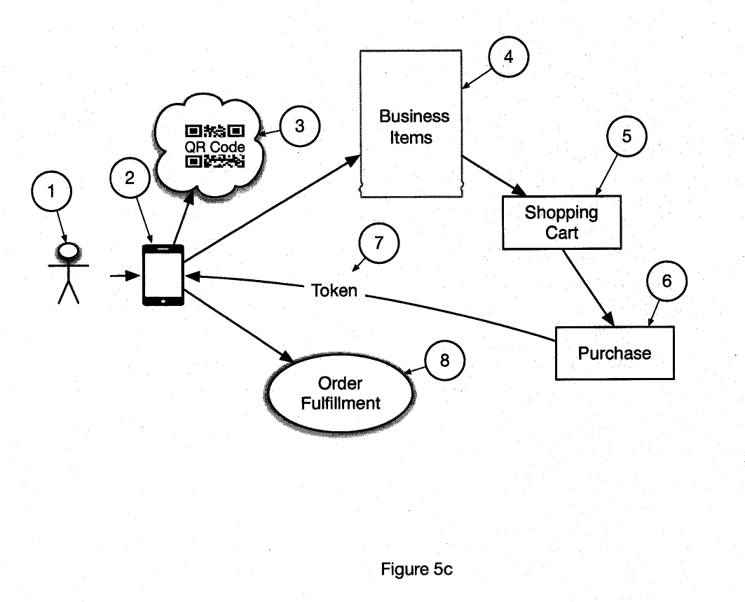

FIG. 5d: Drawing represents the process to buy tickets or getting enrolled for an activity class. Scanning the QR Code (3) launches the service to purchase a ticket (4) or enroll in the class. If enrollment is open a user gets to a cart service (5) and completes the transaction with a purchase receipt (6) and a token generated (7). In case of un-available seats, a status of enrollment closed or tickets sold out is displayed.

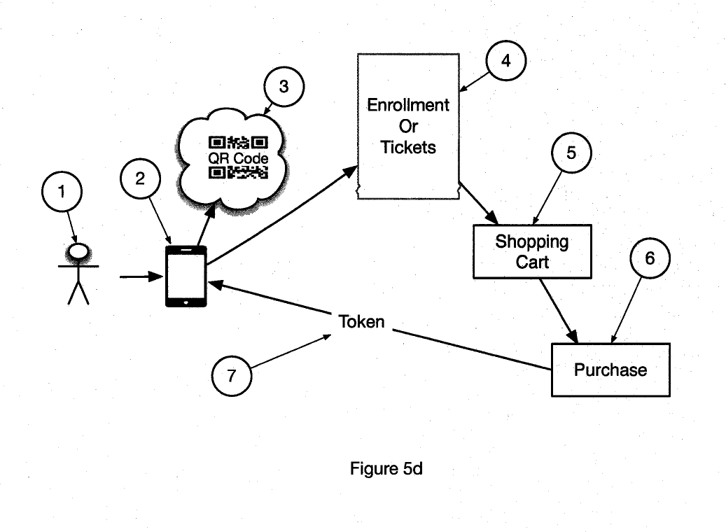

### DETAILED DESCRIPTION OF THE OF INVENTION

This invented method is a solution for generating, assigning, and managing the use of wait tokens. A wait token is a placeholder in a queue assigned by a business or office to their patrons so as to regulate and dispense services on a first come first served basis.

Businesses and offices, interested in providing services to their customers, therefore must employ a mechanism to manage the customers when they show up at the business locations. These customers/consumers may be asked to pull some form of paper token/stub from a dispenser and join a queue. A single queue is probably the norm; in certain businesses/offices there could be multiple queue with different sequences of token.

Some examples of services requiring physical visit where a token system might exist are: Health related services like Doctor & Lab visits, Entertainment centers and Sport activities, Restaurants, Auto repair shops etc.
Multitudes of businesses implement multiple ways to service their on-premise customers. These existing methods have many shortcomings, and they exist due to the very nature of tokens.
For example, if a business/office provides multiple services then it has to:
1. Deploy as many physical token types to distinguish between customers needing different services.
2. Provide enough space for people to stand in queue or a waiting area
3. Provide some manpower to manage the physical tokens (like loading of token rolls, dispensing mechanism etc.)
4. Provide logistics of arranging the tokens and types
   These various methods and mechanisms of managing on-premise customers using physical tokens is what this invention intends to replace.

A business/office wishing to manage customers on premise can register itself using web or mobile. Once the business is registered the business/office can then create a manager/admin account. The manager/admin user can then add new stores under the business or office. For each activity type, which the business wants to extend to its customers, the manager/admin user will have to create an associated queue. Creating a queue will generate a QR Code (or other form of representation like bar code etc.) which when printed and displayed can be scanned by a mobile phones. Customers can then scan these displayed images via a mobile phone and mobile app and join the queues and receive tokens.

For example a store, which has a returns activity can setup a queue online and print the associated QR Code. This printed image of QR Code can then be display at prominent location with some captions. A user can scan the image and join the queue locally when on premise in store or by searching online and clicking the link to join the queue remotely.

In the new process, a customer can optimize his/her time and need not be physically present at a store/office to join a queue, as described above.

For example, if DMV publish all their service queues. A user can then search and join the queue remotely. Customer can also check the status, receive updates to the queue whenever there is some change to queue like an update to “Now Serving” tag. Depending on the waiting times, a user can plan their trip and reach DMV just in time. Thus avoiding unwanted waiting, unnecessary calling and general uncertainty.

In the new process, a patient who wants an appointment will now tap the published QR Code of the doctor, which will pull up the appointment calendar of the doctor. It will show the doctors availability, the appointment calendar and other information of interest to patient. The patient can then choose a suitable appointment slot for himself/herself. Thus saving herself/himself and the doctor's office countless hours of calls and general stress.

In the new process a passenger wishing to travel will scan the QR Code of a train. This action will pull up the ticket purchase and journey options. The passenger can then buy the ticket and travel in comfort.

The same passenger while on train can shop for services available at the next stop. Every service provider will have a QR Code and by choosing the QR Code the user can place orders. The vendor on other have will receive the order along with the QR Code of ticket. Thus provider will have the service/product ready and delivered to passengers seat when train reaches the stop.

1: The method of registering a business activity as a queue.

2: The method of generating wait tokens on a queue.

3: The method as in claim 2 in which a token is generated by scanning a QR Code, RFID Chip, Bar Code, NFC Tag or any such method using a mobile device.

4: The method as in claim 2 in which a token is generated by voice commands using a voice control and recognition system.

5: The method of invoking a service.

6: The method as in claim 5 in which a service like an appointment calendar or a payment service or making a purchase or any other integrated service is invoked by scanning a QR Code.

7: The method as in claim 5 in which a service is invoked by voice commands using a voice control and recognition system.
